(19) United States
(12) Patent Application Publication
(10) Pub. No.: US 2024/0371158 A1
(43) Pub. Date: Nov. 7, 2024

(54) SYSTEM AND METHOD FOR PREDICTING CROP GROWTH STAGE BASED ON SATELLITE TELEMETRY DATA

(71) Applicants: Chun-Hsiao WU, Taipei City (TW); Data Yoo Application CO., LTD., Taipei City (TW)

(72) Inventors: Hao-Ping CHUANG, Taipei City (TW); Chun-Hsiao WU, Taipei City (TW)

(73) Assignees: Chun-Hsiao WU, Taipei City (TW); Data Yoo Application CO., LTD., Taipei City (TW)

(21) Appl. No.: 18/651,028

(22) Filed: Apr. 30, 2024

Related U.S. Application Data
(60) Provisional application No. 63/499,978, filed on May 3, 2023.

(30) Foreign Application Priority Data
Jun. 14, 2023 (TW) 112122122

(51) Int. Cl. G06V 20/10; G06T 7/00; G06V 10/762; G06V 10/82; G06V 20/13

(52) U.S. Cl. CPC G06V 20/188; G06T 7/0012; G06V 10/762; G06V 10/82; G06V 20/13; G06T 2207/10032; G06T 2207/20084; G06T 2207/30188

(57) ABSTRACT

A system for predicting crop growth stage, includes: an input module, receiving telemetric vegetation indices according to telemetric data, and receiving crop growth stage information with the telemetric vegetation indices, which are sensed in time period windows decided by a satellite altitude; and a machine learning module, including a supervised mode and an unsupervised mode. In the supervised mode, the machine learning module generates a prediction model based on the correlation between the telemetric vegetation indices and the crop growth stage information. In the unsupervised mode, the machine learning module collects the telemetric vegetation indices in the same time period window into the same group, and transforms the telemetric vegetation indices into dimension-reduced vegetation indices, to cluster the groups with the same implicit physical characteristics of the dimension-reduced vegetation indices into the same cluster, and to label the telemetric vegetation indices in the same cluster with the same label.

### BACKGROUND OF THE INVENTION

### 1. Field of the Invention

The present invention relates to a system for predicting crop growth stage, especially the system capable of predicting crop growth stage based on telemetric vegetation indices.

### 2. Description of the Prior Art

In prior technology, the operation of crop growth status study based on vegetation data, is highly restricted due to human capability or complicated earth terrain. Therein, how to increase an available size of the area for determining the crop growth status, may be subject to these restrictions. Therein, insufficient manpower can only work for small areas, and is not suitable for large-scale crop growth studies.

Besides, traditional reading for vegetation data often results in errors due to inconsistent tools or inconsistent determination references. These errors may cause great difficulties in integrating vegetation data from different sources.

Further, the machine learning often suffers from the problem of excessive consumption of computing resources. Especially in large-scale information calculations, the demand for the computing resources is even greater.

In view of the above issues, the present invention provides crop growth stage prediction technology based on satellite telemetry technology. Compared with traditional technology, the present invention provides the capability of arranging large-scale vegetation data with downscale computing resource requirements by facilitating machine learning, which achieves large-scale vegetation data computing capabilities and lower computing resource requirements.

### SUMMARY OF THE INVENTION

In one perspective, the present invention provides a system for predicting crop growth stage, which includes: an input module, receiving a plurality of telemetric vegetation indices according to telemetric data obtained from a satellite, or receiving the telemetric vegetation indices and a crop growth stage information in cooperation with the telemetric vegetation indices, wherein the telemetric vegetation indices are sensed (obtained) in time period windows decided by the satellite altitude of detecting the telemetric vegetation indices; and a machine learning module, including a supervised mode and an unsupervised mode in operating a long short-term memory model (LSTM). In the supervised mode, the machine learning module generates a first prediction model (in one embodiment, the first prediction model can be a supervised prediction model) based on the correlation between the telemetric vegetation indices and crop growth stage information. In the unsupervised mode, the machine learning module collects the telemetric vegetation indices sensed in the same time period window into the same group, and transforms the telemetric vegetation indices respectively, into a plurality of dimension-reduced vegetation indices, to cluster the groups with the same implicit physical characteristics of the dimension-reduced vegetation indices into the same cluster, and to label the telemetric vegetation indices in the same cluster with the same label. Therein, the input module and the machine learning module are operated in at least one operating processor, and a data transmission channel between the input module and the machine learning module is formed when operating the input module and the machine learning module.

In one embodiment, the satellite conducts remote sensing of an area, to generate the telemetric vegetation indices corresponding to the area, wherein the telemetric vegetation indices include: biomass, water content, or temperature.

In one embodiment, the satellite is a sun-synchronous satellite, a geostationary satellite, a Molniya orbit satellite, a low-earth orbit satellite, a medium-earth orbit satellite, or a satellite with an inclination orbit:

In one embodiment, the long short-term memory model includes a coding layer and a decoding layer, wherein the telemetric vegetation indices are correspondingly transformed into a plurality of dimension-reduced vegetation indices in the coding layer, and the dimension-reduced vegetation indices are respectively regressed to generate a plurality of regressed telemetric vegetation indices in the decoding layer.

In one embodiment, at least one portion of the same labels of the telemetric vegetation indices, corresponds to the same growth stage in the crop growth stage information.

In one embodiment, after the operation in the unsupervised mode, a second prediction model is obtained in the supervised mode, based on the correlation between the telemetric vegetation indices and the labels. Based on the correlation between telemetric vegetation indices and the same label. In one embodiment, at least one portion of the same labels of the telemetric vegetation indices, corresponds to the same growth stage in the crop growth stage information. In the supervised mode, a second prediction model is obtained based on the correlation between the telemetric vegetation indices and the same labels corresponding to the same growth stage. Therefore, the second prediction model can be a growth prediction model based on the vegetation indices.

In one embodiment, the labels or the crop growth stage information include: harvesting, flowering, bagging, pruning, insect damage, or fruiting. In one embodiment, the harvesting includes: harvesting stage and harvest yield status.

In one embodiment, the telemetric vegetation indices include a plurality of index values. At least one of the index values is generated based on an arithmetic calculation or a logical operation based on some of the other index values.

In one embodiment, one of the telemetric vegetation indices includes a temperature difference between a ground temperature and a crop temperature, and the crop growth stage is determined according to the temperature difference.

In one perspective, the present invention provides a method for predicting crop growth stage, which includes: operating an input module and a machine learning module in at least one operating processor; forming a data transmission channel between the input module and the machine learning module when operating the input module and the machine learning module; the input module receiving a plurality of telemetric vegetation indices from a satellite, or receiving the telemetric vegetation indices and a crop growth stage information in cooperation with the telemetric vegetation indices, wherein the telemetric vegetation indices are sensed (obtained) in time period windows decided by the satellite altitude of detecting the telemetric vegetation indices; and the machine learning module operating a machine learning step, which includes a supervised mode and an unsupervised mode in operating a long short-term memory model (LSTM), wherein in the supervised mode, the machine learning step includes: generating a first prediction model based on the correlation between the telemetric vegetation indices and the crop growth stage information, and wherein in the unsupervised mode, the machine learning step includes: collecting the telemetric vegetation indices sensed in the same time period window into the same group, transforming the telemetric vegetation indices respectively into a plurality of dimension-reduced vegetation indices, clustering the groups with the same implicit physical characteristics of the dimension-reduced vegetation indices into the same cluster, and labeling the telemetric vegetation indices in the same cluster with the same label.

In one embodiment of the aforementioned crop growth stage prediction method, the telemetric vegetation indices comprise biomass, water content, or temperature.

In one embodiment of the aforementioned crop growth stage prediction method, a portion of the same label corresponds to the same growth stage in the crop growth stage information.

In one embodiment of the aforementioned crop growth stage prediction method, after the operation in the unsupervised mode, a second prediction model is obtained in the supervised mode, based on the correlation between the telemetric vegetation indices and the labels corresponding to the telemetric vegetation indices.

In one embodiment of the aforementioned crop growth stage prediction method, the label or the crop growth stage information, includes: harvesting, flowering, bagging, pruning, insect damage, or fruiting. In one embodiment, the harvesting includes: harvesting stage and harvest yield status.

The objectives, technical details, features, and effects of the present invention will be better understood in reference with the detailed description of the embodiments below, together with the attached drawings.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIGS. 1, 1A, and 1B show several schematic diagrams of a system for predicting crop growth stage according to the present invention;

FIG. 2 shows a schematic diagram of a satellite remotely sensing the telemetric data on the earth surface;

FIG. 3 shows a schematic diagram of the operation in unsupervised mode according to one embodiment of the present invention;

FIGS. 4A to 4C, respectively show plural images for illustrating several telemetric vegetation indices;

FIG. 5 shows a schematic diagram of a long short-term memory model (LSTM) according to one embodiment of the present invention;

FIG. 6 shows a schematic diagram of the correlation between telemetric vegetation indices and the crop growth stage information according to one embodiment of the present invention;

FIG. 7 shows a schematic diagram of the correlation between telemetric vegetation indices and crop growth stage information according to one embodiment of the present invention;

FIGS. 8A, 8B, 8C, and 8D show schematic diagrams of the operation steps of the long short-term memory model according to one embodiment of the present invention;

FIG. 9 shows a schematic diagram of the system for predicting crop growth stage according to one embodiment of the present invention;

FIGS. 10 and 11 show schematic diagrams for comparing the real crop growth stages with the predicted growth stages of the present invention.

### DETAILED DESCRIPTION OF THE PREFERRED EMBODIMENTS

The drawings as referred to throughout the description of the present invention are for illustration only, to show the interrelations between the steps, or the modules, but not drawn according to an actual scale of sizes.

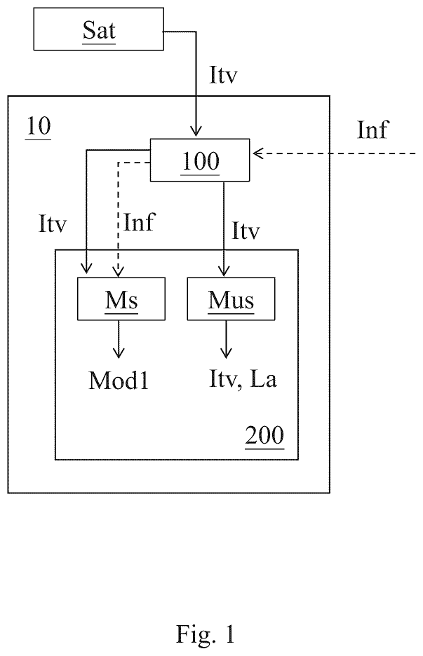

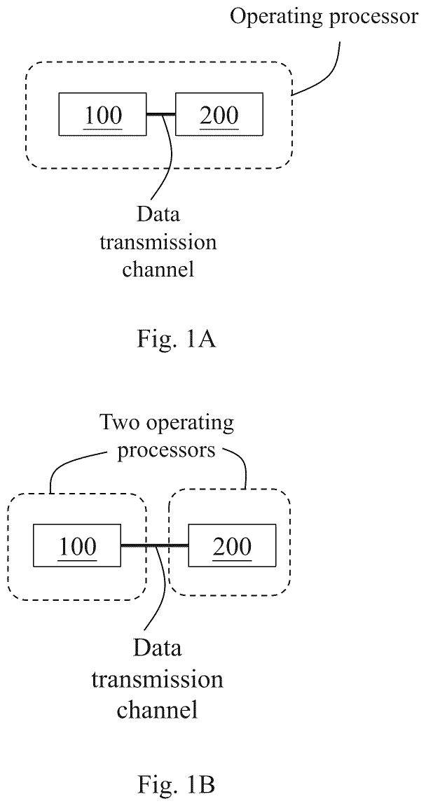

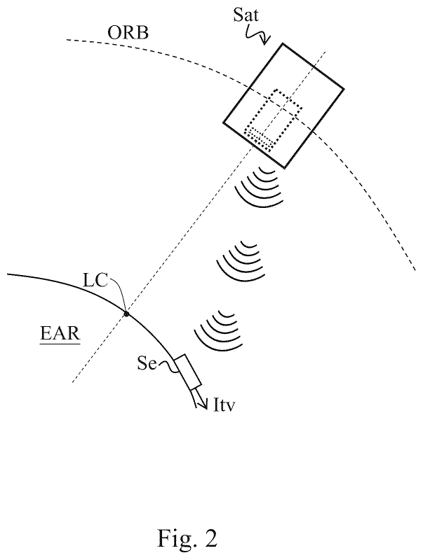

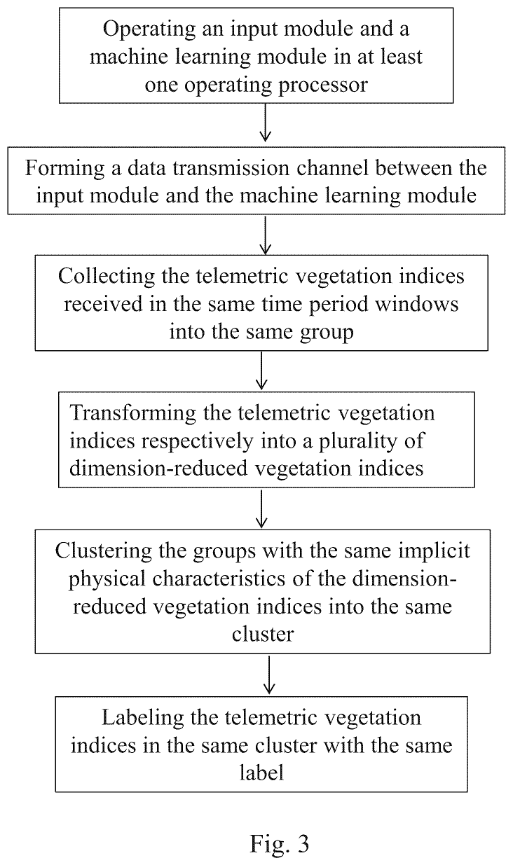

In one perspective, as shown in FIG. 1, the present invention provides a system 10 for predicting crop growth stage, which includes: an input module 100, receiving a plurality of telemetric vegetation indices Itv, or receiving the telemetric vegetation indices Itv and a crop growth stage information Inf in cooperation with the telemetric vegetation indices Itv, wherein the telemetric vegetation indices Itv are sensed in time period windows decided by the satellite altitude of detecting the telemetric vegetation indices Itv corresponding to a surface location LC on the earth EAR as shown in FIG. 2; and a machine learning module 200, including a supervised mode Ms and an unsupervised mode Mus in operating a long short-term memory model (LSTM). In the supervised mode Ms, the machine learning module 200 generates a first prediction model (in one embodiment, the first prediction model can be a supervised prediction model Mod1) based on the correlation between the telemetric vegetation indices Itv and the crop growth stage information Inf. When the first prediction model is obtained, newly received the telemetric vegetation indices Itv can be used to predict a new crop growth stage information Inf based on the first prediction model Mod1. In FIG. 2, the telemetric vegetation indices Itv may be generated directly from the satellite Sat; or, after the ground station Se receives telemetry data from the satellite Sat, the telemetric vegetation indices Itv are generated according to the telemetry data from the satellite Sat. When the telemetric vegetation indices Itv and the crop growth stage information Inf are known, the system 10 for predicting crop growth stag can generate the first prediction model Mod1 in the supervised mode Ms. The first prediction model Mod1 (or, the prediction model generated by the supervised mode Ms) can be generated in the supervised mode Ms. As shown in FIG. 3, when only the telemetric vegetation indices Itv are known, or the telemetric vegetation indices Itv are subjected to machine learning, the unsupervised mode Mus can be used to predict the crop growth stage corresponding Inf to the telemetric vegetation indices Itv. In the unsupervised mode Mus, the machine learning module 200 collects the telemetric vegetation indices Itv sensed in the same time period window into the same group, and transforms the telemetric vegetation indices Itv respectively into a plurality of dimension-reduced vegetation indices Idr, to cluster the groups with the same implicit physical characteristics of the dimension-reduced vegetation indices Idr (based on the same index characteristics of the dimension-reduced vegetation indices Idr obtained in the machine learning) into the same cluster, and to label the telemetric vegetation indices Itv in the same cluster with the same label. Therein, the input module 100 and the machine learning module 200 are operated in at least one operating processor (FIGS. 1A and 1B), and a data transmission channel between the input module 100 and the machine learning module 200 is formed when operating the input module 100 and the machine learning module 200 (FIGS. 1A and 1B). According to the present invention, the telemetric vegetation indices Itv are collected into groups according to the accepted time period windows, and the telemetric vegetation indices Itv are respectively transformed for reducing the computational time required, which in turn significantly reduces the resources required for the machine learning calculation.

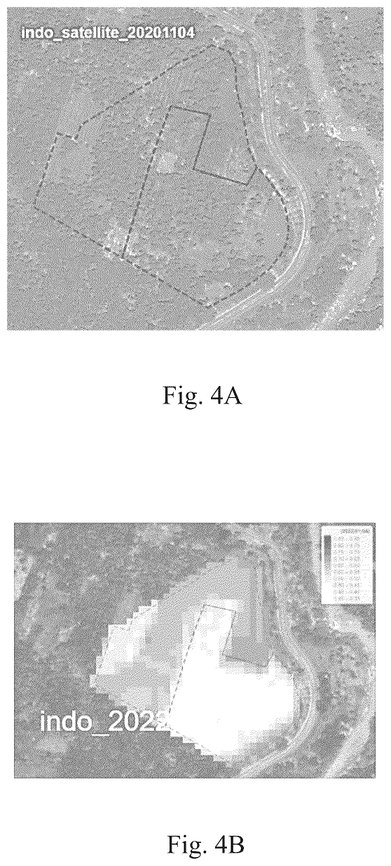

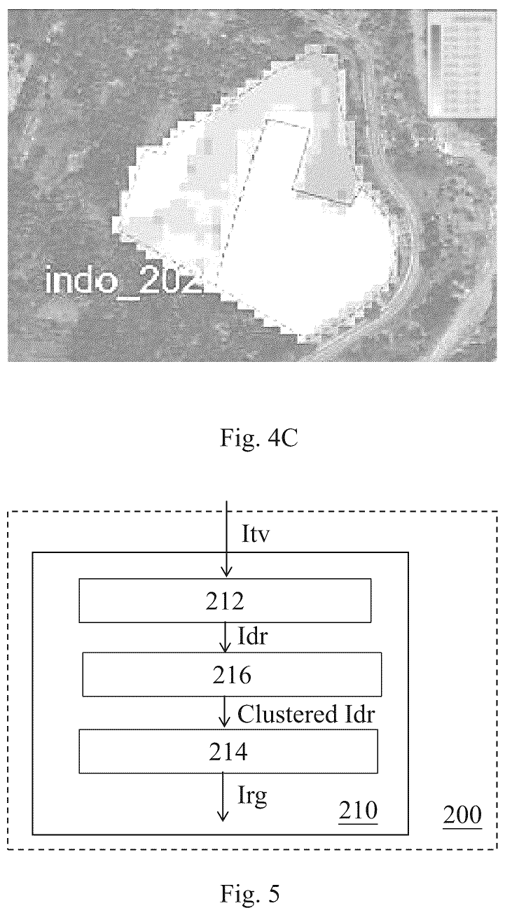

In one embodiment, the satellite Sat conducts remote sensing of the surface location LC, to generate the telemetric vegetation indices Itv corresponding to the surface location LC, wherein the telemetric vegetation indices Itv include: biomass, water content, or temperature. The telemetric vegetation indices Itv can further include other indices, such as normalized difference red edge (NDRE), normalized difference vegetation index (NDVI), and normalized difference water index (NDWI), and so on. These indices are mainly the telemetric vegetation indices Itv obtained by optical telemetry of the satellite Sat. FIGS. 4A to 4C show the image patterns of the telemetric vegetation indices Itv. In one embodiment, FIG. 4A shows the visible light image, FIG. 4B shows the distribution of the telemetric vegetation indices Itv based on the biomass, and FIG. 4C shows the distribution of the telemetric vegetation indices Itv for the water content (for example, soil moisture content, vegetation water content, and so on). In one embodiment, the biomass includes soil fertility, and soil metabolic profile.

In addition, the technology provided by the present invention can be applied to the growth stage prediction based on various changes of physical or chemical phenomenon. For example, a ground temperature and a crop temperature can be included for determining the telemetric vegetation indices Itv, such as changes in the difference between the ground temperature and crop temperature. For example, when the crop is fruiting, due to the large increase in inner organic material such as sugars or carbohydrate, the internal specific heat of the crop rises considerably. Surrounded by a gradual increase in ground temperature due to sunlight in the morning, the crop temperature rises slower than the ground temperature. For the same reason, when the ground temperature gradually decreases in the evening, the crop temperature decreases slower than the ground temperature. Another example is that when the crop is subjected to insect damage, under the influence of physiological and chemical reactions caused by the insect damage, the crop temperature variation can be chaotic and is not correlated to or in low correlation with the ambient temperature. That is, the temperature difference between the ground temperature and the crop temperature can be also chaotic. At this time, crop growth stage applications such as deworming can be operated according to the prediction technology provided by the present invention. In this way, according to the present invention, the telemetric vegetation indices Itv based on various physical characteristics can be used to predict various crop growth stages besides the traditional vegetation prediction technology.

In one embodiment as shown in FIG. 2, according to the remote sensing requirements, the satellite can be a sun-synchronous satellite, a geostationary satellite, a Molniya orbit satellite, a low-earth orbit satellite, a medium-earth orbit satellite, or a satellite with an inclination orbit. The sun-synchronous satellites are orbiting around the earth EAR, with a combination of altitude and inclination of the orbit, whether at the ascending or descending intersection point, the satellite Sat is in the same time zone of the earth EAR. The satellite with the inclination orbit, orbits around the earth EAR in an orbital plane angled to the equatorial plane of the earth EAR. The Molniya orbit satellite moves around the earth EAR in an elliptical orbit. When the Molniya orbit satellite adjusts its attitude near the earth EAR to take images, the Molniya orbit satellite is in a closer altitude to the earth surface for improving the resolution of the remote sensing images. In addition, geosynchronous satellites can also be used for long-term continuous telemetry. In addition, users can choose the type of satellite according to their remote sensing needs without being limited to the aforementioned types of satellites.

As shown in FIG. 5, in one embodiment, the long short-term memory model (LSTM) 210 includes a coding layer 212 and a decoding layer 214, wherein the telemetric vegetation indices Itv are correspondingly transformed into a plurality of dimension-reduced vegetation indices Idr in the coding layer 212, and the dimension-reduced vegetation indices Idr are respectively regressed to generate a plurality of regressed telemetric vegetation indices Irg in the decoding layer 214. In one embodiment, the long short-term memory model 210 can be used in the unsupervised mode Mus and the supervised mode Ms. The operation of the long short-term memory model 210 is detailed in the following embodiments.

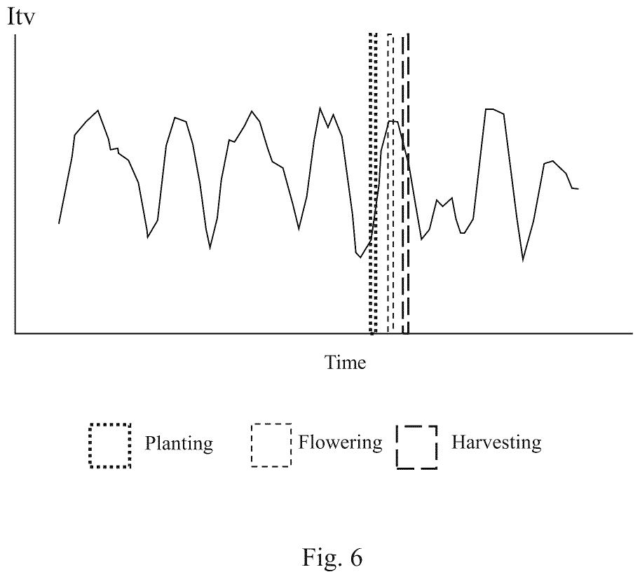

As shown in FIG. 6, it shows the correlation between the telemetric vegetation indices Itv and the crop growth stage information Inf. The telemetric vegetation indices Itv vary with the time sequence. Taking one section of the telemetric vegetation indices Itv curve as an example, the trends of the telemetric vegetation indices Itv in the time sequence, can respectively correspond to the growth stages of planting, flowering, and harvesting. This is an illustrative example. Users can also make use of the correlation between the telemetric vegetation indices Itv and other growth stages in the crop growth stage information Inf. In one embodiment, the harvesting includes: harvesting stage and harvest yield status.

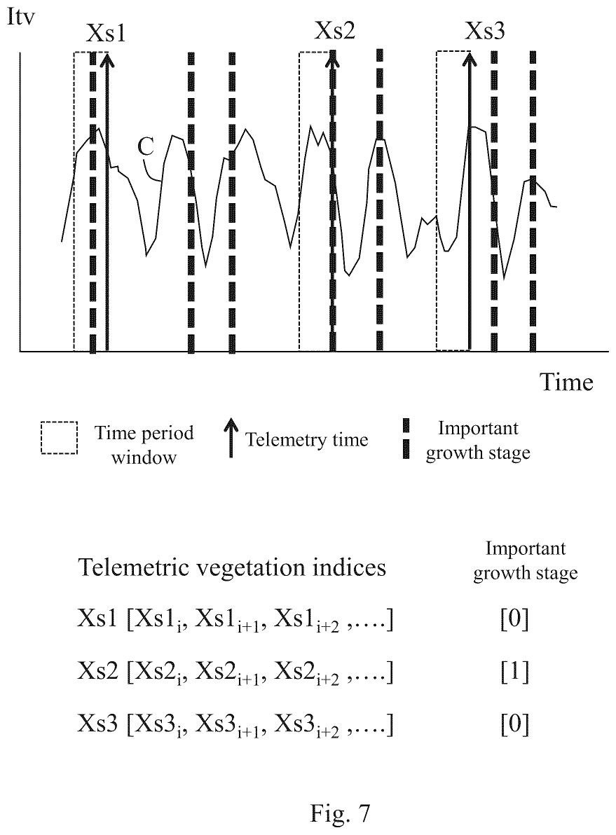

As shown in FIG. 7, the operation process in supervised mode Ms according to one embodiment, is described as follows: a curve C of the telemetric vegetation indices Itv, corresponds to multiple important growth stages in time sequence (chronological order), and multiple time period windows used for grouping and sensing the telemetric vegetation indices Itv, respectively. For example, the important growth stages may include: harvesting, flowering, bagging, pruning, insect damage, fruiting, and other growth stages. Each of the time period windows corresponding to the arrows shown in FIG. 7, is the time of remote sensing by the satellite Sat, which respectively generates telemetric vegetation index data Xs1, Xs2, Xs3, and so on. The telemetric vegetation index data Xs1, Xs2, Xs3, etc., include multiple values Xs1i, Xs1i+1, Xs1i+2, Xs2i, Xs2i+1, Xs2i+2, Xs3i, Xs3i+1, Xs3i+2, etc. In FIG. 7, wherein “0” is a number corresponding to none of the important growth stages, and “1” is a number corresponding to one of the important growth stages. Through the correlation between these telemetric vegetation indices Itv and the crop growth stage information Inf, the first prediction model Mod1 (or, the supervised prediction model) can be generated.

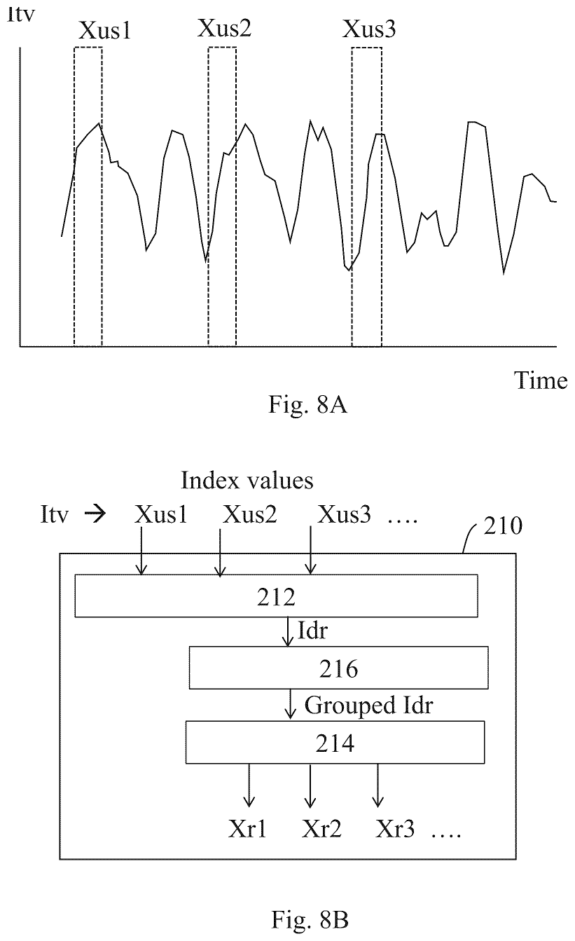

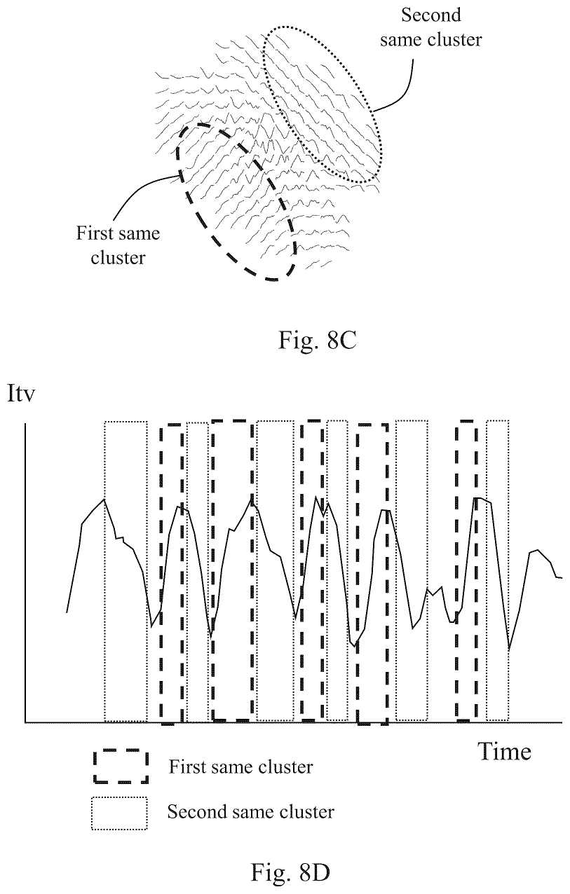

As shown in FIGS. 5, 8A, and 8B, the operation of the unsupervised mode Mus in one embodiment is described as follows: after receiving the telemetric vegetation indices Itv, the telemetric vegetation indices Itv sensed in the same time period window, are collected into the same group. That is, the telemetric vegetation indices Itv are received by multiple time period windows in chronological order, and respectively collected into the groups Xus1, Xus2, Xus3, etc. The telemetric vegetation indices Itv are transformed into the dimension-reduced vegetation indices Idr. After a latent space 216 receives the dimension-reduced vegetation indices Idr, the dimension-reduced vegetation indices Idr with the same implicit physical characteristics (based on the same index characteristics of the dimension-reduced vegetation indices Idr obtained in the machine learning) are determined to be in the same cluster. The dimension-reduced vegetation indices Idr are regressed in the decoding layer 214 to generate the regressed telemetric vegetation indices Irg (regressed telemetric vegetation index data Xr1, Xr2, Xr3, etc. in FIG. 8B). As shown in FIG. 5, the machine learning module 200 labels the dimension-reduced vegetation indices Idr in the same cluster with the same label (FIG. 8C, wherein the first and second same clusters are taken as examples). That is, in the long short-term memory model 210, the telemetric vegetation indices Itv in the same cluster are labeled with the same label La. The telemetric vegetation indices Itv corresponding to the same index characteristics (or, the same implicit physical characteristics) are labeled with the same label La, which corresponds to the same growth stage in the crop growth stage information Inf (FIG. 8D). In this implementation example, the same label La of the telemetric vegetation indices Itv obtained by the machine learning module 200, can also be used to correspond to various possible crop growth stage (especially, in case that no corresponding growth stage information provided in the crop growth stage information Inf). When the crop growth stage information Inf does not provide corresponding information, this technology can be used for further analysis and forecasting.

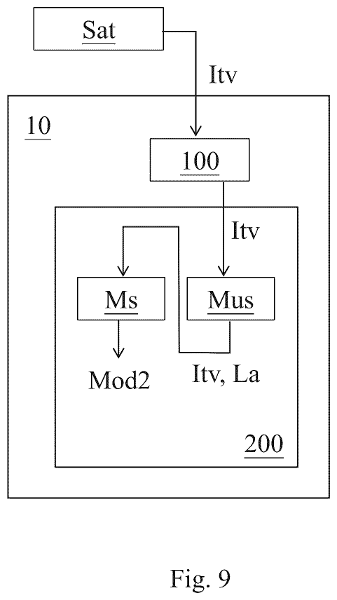

In another embodiment of the system 10 for predicting the crop growth stage shown in FIG. 9, after the unsupervised mode Mus, the telemetric vegetation indices Itv, and the label La of the telemetric vegetation indices Itv corresponding to the crop growth stage information Inf, can be operated in the supervised mode Ms. Based on the correlation between the telemetric vegetation indices Itv and the label La generated in the unsupervised mode Mus, a second prediction model Mod2 is obtained in the supervised mode Ms. In this way, the present invention not only generates a prediction model by the unsupervised mode Mus, but also operates in the supervised mode Ms with the telemetric vegetation indices Itv (by the correlation between the cluster and the dimension-reduced vegetation indices Idr). When a part of the same labels La corresponds to the crop growth stage in the crop growth stage information Inf, the telemetric vegetation indices Itv can be determined, and a correlation between the telemetric vegetation indices Itv and the crop growth stage information Inf can be determined, to generate a prediction model. The prediction model can be a lifetime growth prediction model based on the telemetric vegetation indices Itv. Thus, the present invention provides at least three machine learning modes: the supervised mode Ms, the unsupervised mode Mus, and a combination mode of combining the supervised mode Ms with the unsupervised mode Mus.

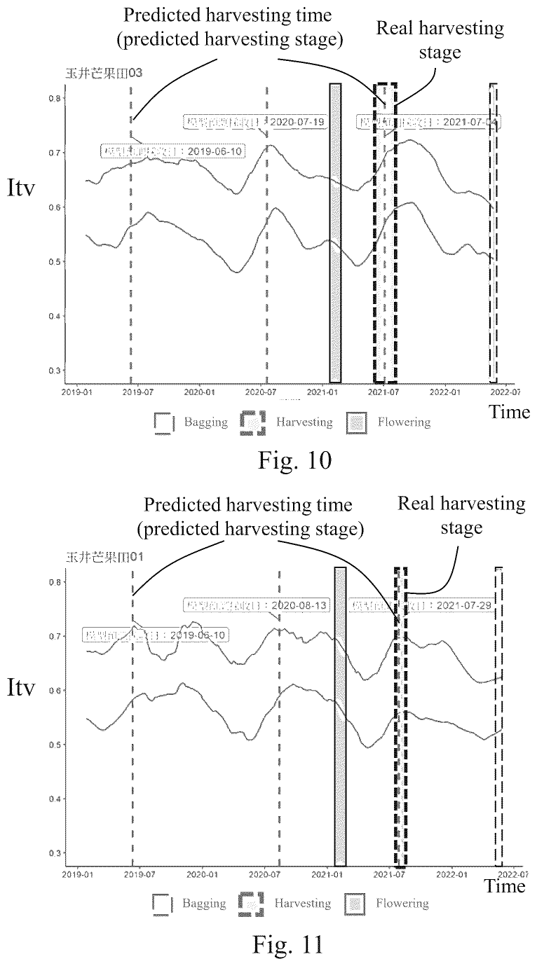

As shown in FIGS. 10 and 11, a real examination is carried out to testify the technology provided by the present invention. In the figures, there are two sets of the telemetric vegetation indices Itv, mainly for harvesting stage prediction therein. According to the figures, under different conditions, the real harvesting stage (bold dashed box) and predicted harvesting stage (vertical bold dotted line) is consistent. In the figures, the real harvesting stage (bold dashed box) and the predicted harvesting stage (vertical bold dotted line) are coincident under different conditions. In this way, the machine learning method provided by the present invention is effective in practical application.

In one embodiment, the telemetric vegetation indices Itv includes a plurality of index values, wherein at least one of the index values is generated based on an arithmetic calculation or a logical operation based on some of the other index values; for example, a time difference between the different telemetric vegetation indices Itv for the same growth stage. Or, at least one of the relevant telemetric vegetation indices Itv is chosen with priority for determination purpose, wherein this arithmetic calculation or the logical operation is operated under various conditions, such as whether the relevant telemetric vegetation indices Itv are above a threshold, or whether most of the relevant telemetric vegetation indices Itv are above a threshold, and so on. The determination can be obtained under various conditions, such as the majority of the relevant telemetric vegetation indices Itv are above a threshold value. The generated arithmetic value or logical operation result, can be regarded as a determination index based on the mutual combination of the relevant telemetric vegetation indices Itv (or, comparison result between the relevant telemetric vegetation indices Itv). For example, some of the telemetric vegetation indices Itv generated by the aforementioned optical remote sensing, or the difference between the ground temperature and the crop temperature, etc.

In one perspective, the present invention provides a method for predicting crop growth stage, which includes: operating an input module 100 and a machine learning module 200 in at least one operating processor; forming a data transmission channel between the input module 100 and the machine learning module 200 when operating the input module 100 and the machine learning module 200; the input module 100 receiving a plurality of telemetric vegetation indices Itv from a satellite Sat, or receiving the telemetric vegetation indices Itv and a crop growth stage information Inf in cooperation with the telemetric vegetation indices Itv, wherein the telemetric vegetation indices Itv are sensed in time period windows decided by the satellite altitude of detecting the telemetric vegetation indices Itv; and the machine learning module 200 operating a machine learning step, which includes a supervised mode Ms and an unsupervised mode Mus in operating a long short-term memory model (LSTM), wherein in the supervised mode Ms, the machine learning step includes: generating a first prediction model Mod1 based on the correlation between the telemetric vegetation indices Itv and the crop growth stage information Inf, and wherein in the unsupervised mode Mus, the machine learning step includes: collecting the telemetric vegetation indices Itv sensed in the same time period window into the same group, transforming the telemetric vegetation indices Itv respectively into a plurality of dimension-reduced vegetation indices Idr, clustering the groups with the same implicit physical characteristics of the dimension-reduced vegetation indices Idr into the same cluster, and labeling the telemetric vegetation indices Itv in the same cluster with the same label. For detailed descriptions of each of these steps, please refer to other examples mentioned above, which are not repeated here.

In the present invention, the aforementioned predicting technology can be not limited to crop growth stage prediction, other important crop sensing or prediction applications are also available by the present invention, such as crop health status inspection (that is, the crop growth stage information can include crop health status). Disease and inset damage usually exit inside the crops, such that they are difficult to be discovered in an early stage. Especially for large-scale planting, it is more difficult to discover the disease and the inset damage in the early stage by manpower. By the time they are discovered, the disease and the inset damage already become serious disasters. In the present invention, the telemetric vegetation indices Itv can be also used to determine the crop health status. The detail of determining the crop health status, can be referred to the aforementioned detail of other embodiment, especially in the operation of the machine learning module.

Therefore, through the above descriptions, all embodiments of the replaceable frame assembly according to the present invention have been introduced completely and clearly. It is worth emphasizing that, the above description is based on embodiments of the present invention. However, the embodiments are not intended to limit the scope of the present invention, and all equivalent implementations or alterations within the spirit of the present invention still fall within the scope of the present invention.

What is claimed is:

1. A system for predicting crop growth stage, including:
an input module, receiving a plurality of telemetric vegetation indices according to telemetric data obtained from a satellite, or receiving the telemetric vegetation indices and a crop growth stage information in cooperation with the telemetric vegetation indices, wherein the telemetric vegetation indices are sensed in time period windows decided by the satellite altitude of detecting the telemetric vegetation indices; and
a machine learning module, including a supervised mode and an unsupervised mode in operating a long short-term memory model (LSTM), wherein in the supervised mode, the machine learning module generates a first prediction model based on the correlation between the telemetric vegetation indices and the crop growth stage information, and wherein in the unsupervised mode, the machine learning module collects the telemetric vegetation indices sensed in the same time period window into the same group, and transforms the telemetric vegetation indices respectively into a plurality of dimension-reduced vegetation indices, to cluster the groups with the same implicit physical characteristics of the dimension-reduced vegetation indices into the same cluster, and to label the telemetric vegetation indices in the same cluster with the same label;
wherein the input module and the machine learning module are operated in at least one operating processor, and a data transmission channel between the input module and the machine learning module is formed during the operation of the input module and the machine learning module.

2. The system for predicting crop growth stage according to claim 1, wherein the satellite conducts remote sensing of an area, to generate the telemetric vegetation indices corresponding to the area, wherein the telemetric vegetation indices include: biomass, water content, or temperature.

3. The system for predicting crop growth stage according to claim 2, wherein the biomass includes: soil fertility, and soil metabolic profile.

4. The system for predicting crop growth stage according to claim 1, wherein the telemetric vegetation indices include: normalized difference red edge (NDRE), normalized difference vegetation index (NDVI), and normalized difference water index (NDWI).

5. The system for predicting crop growth stage according to claim 1, wherein the satellite includes: a sun-synchronous satellite, a geostationary satellite, a satellite with an inclination orbit, or a Molniya orbit satellite.

6. The system for predicting crop growth stage according to claim 1, wherein the long short-term memory model includes a coding layer and a decoding layer, wherein the telemetric vegetation indices are correspondingly transformed into a plurality of dimension-reduced vegetation indices in the coding layer, and the dimension-reduced vegetation indices are respectively regressed to generate a plurality of regressed telemetric vegetation indices in the decoding layer.

7. The system for predicting crop growth stage according to claim 1, wherein at least one portion of the same labels of the telemetric vegetation indices, corresponds to the same growth stage in the crop growth stage information.

8. The system for predicting crop growth stage according to claim 1, wherein after the operation in the unsupervised mode, a second prediction model is obtained in the supervised mode, based on the correlation between the telemetric vegetation indices and the labels.

9. The system for predicting crop growth stage according to claim 1, wherein the labels or the crop growth stage information include: harvesting, flowering, bagging, pruning, insect damage, or fruiting.

10. The system for predicting crop growth stage according to claim 9, wherein the harvesting includes harvesting stage and harvest yield status.

11. The system for predicting crop growth stage according to claim 1, wherein the telemetric vegetation indices include a plurality of index values, and at least one of the index values is generated based on an arithmetic calculation or a logical operation based on some of the other index values.

12. The system for predicting crop growth stage according to claim 1, wherein the crop growth stage information includes crop health status.

13. A method for predicting crop growth stage, including:
operating an input module and a machine learning module in at least one operating processor;
forming a data transmission channel between the input module and the machine learning module when operating the input module and the machine learning module;
the input module receiving a plurality of telemetric vegetation indices from a satellite, or receiving the telemetric vegetation indices and a crop growth stage information in cooperation with the telemetric vegetation indices, wherein the telemetric vegetation indices are sensed in time period windows decided by the satellite altitude of detecting the telemetric vegetation indices; and
the machine learning module operating a machine learning step, which includes a supervised mode and an unsupervised mode in operating a long short-term memory model (LSTM), wherein in the supervised mode, the machine learning step includes: generating a first prediction model based on the correlation between the telemetric vegetation indices and the crop growth stage information, and wherein in the unsupervised mode, the machine learning step includes: collecting the telemetric vegetation indices sensed in the same time period window into the same group, transforming the telemetric vegetation indices respectively into a plurality of dimension-reduced vegetation indices, clustering the groups with the same implicit physical characteristics of the dimension-reduced vegetation indices into the same cluster, and labeling the telemetric vegetation indices in the same cluster with the same label.

14. The method for predicting crop growth stage according to claim 13, wherein the telemetric vegetation indices include: biomass, water content, or temperature.

15. The method for predicting crop growth stage according to claim 13, wherein the telemetric vegetation indices include: normalized difference red edge (NDRE), normalized difference vegetation index (NDVI), and normalized difference water index (NDWI).

16. The method for predicting crop growth stage according to claim 13, wherein the telemetric vegetation indices with the same label, correspond to the same growth stage in the crop growth stage information.

17. The method for predicting crop growth stage according to claim 13, further includes: after the operation in the unsupervised mode, generating a second prediction model in the supervised mode, based on the correlation between the telemetric vegetation indices and the labels.

18. The method for predicting crop growth stage according to claim 13, wherein the labels or the crop growth stage information include: harvesting, flowering, bagging, pruning, insect damage, or fruiting.

19. The system for predicting crop growth stage according to claim 18, wherein the harvesting includes harvesting stage and harvest yield status.

20. The method for predicting crop growth stage according to claim 13, wherein the crop growth stage information includes crop health status.
